(19) United States
(12) Patent Application Publication
(10) Pub. No.: US 2003/0182460 A1
(43) Pub. Date: Sep. 25, 2003

(54) Managed code modules dynamically invoking unmanaged code modules at arbitrary locations

(76) Inventor: Atul Khare, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/106,974

(22) Filed: Mar. 25, 2002

(51) Int. Cl. G06F 15/163; G06F 9/54; G06F 9/00; G06F 9/45

(52) U.S. Cl. 709/310

(57) ABSTRACT

At compile-time, a managed code module does not know the location of an unmanaged code module on the code execution system where the managed code is to be executed. A wrapper function in the managed code module specifies the desired function in the unmanaged code module, and parameters to pass to/from that function. At runtime, the managed code environment or the managed code determines the location of the unmanaged code module, and the managed code environment generates a dynamic assembly specifying the location, the function, and the parameters. The code execution system executes the dynamic assembly as proxy for the unmanaged code module.

### BACKGROUND OF THE INVENTION

1. Technical Field of the Invention

This invention relates generally to execution of software, and more especially to execution of code modules whose location is unknown at compile time.

2. Background Art

In conventional computer software execution environments, such as Windows environments, a software application can be comprised of several modules, including executable (EXE) modules and dynamically linked library modules (DLL) and the like. These environments are referred to as “unmanaged” because the application software source code is compiled into a native executable format (such as Intel IA-32 architecture or X86 code) which is allowed to make direct calls to operating system (OS) service routines and libraries, as well as to other modules of the application. The various modules of the application are, after compilation, joined by a linker program to create the software application. The resulting code is not validated or verified by the OS. When the user launches the application, the OS simply loads the application and executes it. There is no realistic way for the OS to confirm, for example, that the application is not doing malicious things such as a opening files owned by other applications and damaging them or copying their data.

More recently, managed environments have become known, such as the Microsoft .NET environment. In the managed environment, the application source code is not compiled to a native executable format, but rather to an intermediate language (IL) format. When the user launches the application, the OS loads the IL code, validates or verifies it, and translates it into native code with a just-in-time (JIT) compiler. The resulting code is then executed.

In some circumstances, it can be necessary for the managed code to make calls to functions that reside in unmanaged code modules, such as DLLs. This is made possible by a .NET technology called PInvoke, or platform invoke, which uses a dummy function in the managed code that has the same method signature (i.e. it takes the same number and kind of parameters) as the unmanaged code. When the dummy method is invoked inside managed code, the call is automatically routed to the actual function that resides in the unmanaged DLL. This feature is commonly exposed in programming languages by using a compiler feature known as the “DLLImport” attribute.

In order to call the unmanaged DLL, the managed code must know where the unmanaged DLL is located. Typically, this means that the managed code needs to know the specific directory on which specific storage drive on which specific computer in the system in which the unmanaged module is stored. One option is to hard-code the location in the source code. Unfortunately, if the unmanaged module is moved to a different location, the application will not run. Another option is to specify only the filename of the unmanaged module in the application source code, and copy the unmanaged module into some directory where the application is stored. Unfortunately, the application directory may change at runtime, and the application will fail. Also, this can result in multiple copies of the unmanaged module being deposited at many locations in the storage system, unnecessarily wasting space and perhaps causing version control problems. Another option is to either add the unmanaged module to some predetermined directory and then add that directory to the search path specifier of the system (e.g. the PATH variable in a DOS or Windows environment), or to add the unmanaged module to a directory that is already specified in the search path specifier. However, one of the key points of some managed environments, including the .NET environment, is that applications should install themselves without requiring any modification to any shared resource, such as the search path specifier or the system registry.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows examples of a code creation system and a code execution system according to this invention.

FIG. 2 show a flowchart of an exemplary method of operation of the invention.

### DETAILED DESCRIPTION

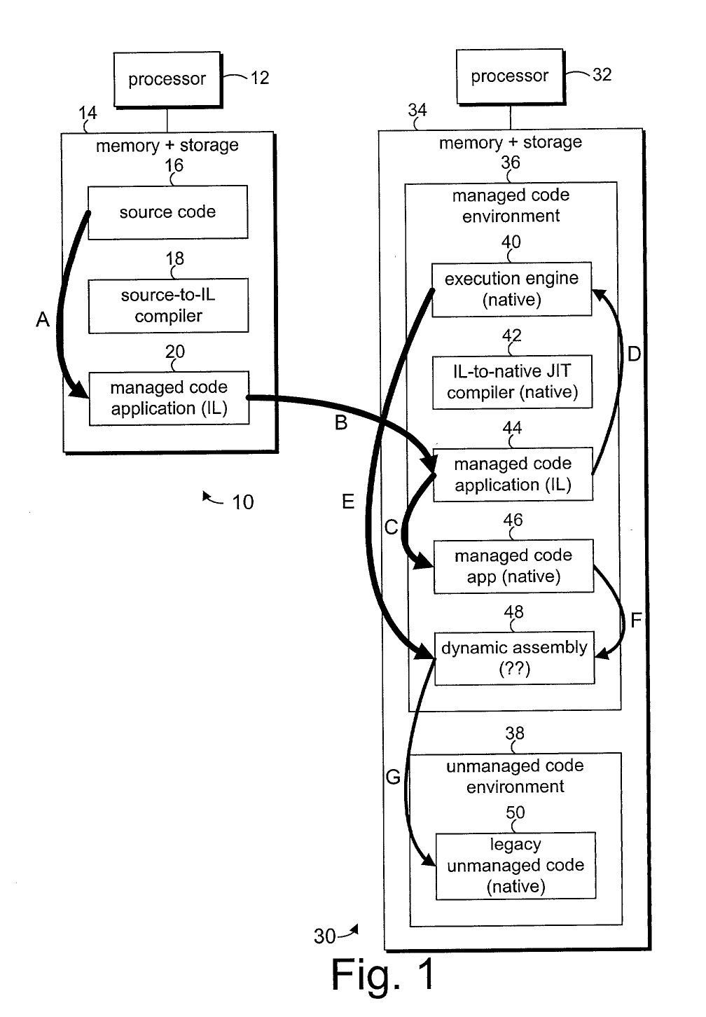

FIG. 1 illustrates one embodiment of the dynamic assembly invocation system of this invention, illustrating both an application creation system 10 such as that of a software vendor, and an application execution system 30 such as that of an end user.

The application creation system includes a processor 12 for performing logic operations of the system, and a memory and storage system 14 for storing data and programs. The source code 16 of the application program is compiled (as indicated by thick arrow A) by a source-to-IL compiler 18 into a managed code application 20 which is in IL format. The resulting application is sold or otherwise delivered to the end user (as suggested by thick arrow B), who loads his copy of the managed code application 44 onto his system.

The application execution system includes a processor 32 for performing logic operations of the system, and a memory and storage system 34 for storing data and programs. The application execution system includes a managed code environment 36 and an unmanaged code environment 38. The managed code environment includes an execution engine 40 and an IL-to-native JIT compiler 42, each typically in native executable format. When the user launches the managed code application, the execution engine loads it and validates/verifies it and, if the validation indicates that the managed code is suitable for execution, the IL-to-native JIT compiler generates (as suggested by thick arrow C) managed application code 46 in native executable format, which is executed by the processor to perform the intended operations of the application software. At the point in the code where the managed application needs to call a routine in the unmanaged code module 50, whose location is unknown, the managed code application 44 issues a call (as suggested by thin arrow D) to the execution engine 40 to create a dynamic assembly 48 which knows where the unmanaged code module is stored. In one embodiment, the managed code application will have, prior to issuing this call (which can be a Reflection call in the .NET environment), executed instructions to determine the location of the unmanaged code module. In another embodiment, the managed code environment provides this service for the managed code application. Determining the location of the unmanaged code module can be done in various ways, such as searching a directory listing, or by asking the user to browse to the unmanaged code module, or the like. The execution engine (or, alternatively, some other entity in the managed code environment) generates the dynamic assembly 48 (as suggested by thick arrow E), and returns a reference to the dynamically generated assembly to the managed code application. The managed code application then issues a call (as suggested by thin arrow F) to the dynamic assembly, and the dynamic assembly issues a corresponding call to the unmanaged code module (as suggested by thin arrow G), which is executed to perform the unmanaged legacy operation.

Although the .NET environment is not the only suitable managed environment in which this invention can be practiced, it is a useful example for explaining the invention and its operation. Managed .NET code is written in a .NET language such as C# or VB.NET, and is compiled into IL format. The .NET runtime environment provides management features such as garbage collection, automatic buffer overrun checks, and the like. Managed code offers great improvement in developer productivity, since the runtime environment itself handles many of the most problematic issues such as memory allocation and deallocation, and the application itself does not need to. The .NET runtime engine is also known as the Common Language Runtime. The .NET framework, which is based in the common language, offers a wide variety of classes that wrap the services exposed by the underlying Windows OS.

However, it is sometimes necessary for managed application code to perform certain tasks that are not possible from within the managed world. In other cases, it may be necessary to access legacy code that was not written as managed code. Typically, these are done by interfacing to functions that reside in unmanaged DLLs.

This invention provides a means for facilitating application code that does not or perhaps cannot know at compile-time where the particular DLL will exist at runtime. This invention enables managed code to interface with functions in DLLs that reside in any arbitrary locations, by using a .NET technology called Reflection. Reflection allows a program to determine, at runtime, the metadata that is a constituent part of any .NET managed program, and allows a program to create “assemblies” at runtime. Assemblies are units of execution in the .NET world, and can be either executables (EXE) or dynamic link libraries (DLL).

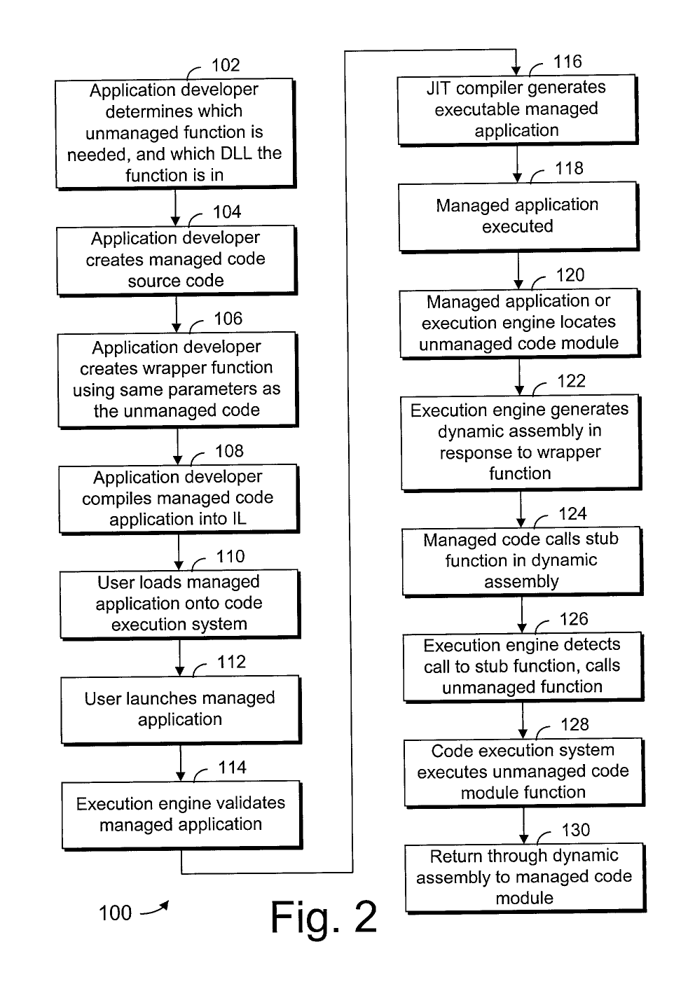

FIG. 2 illustrates one method 100 of operation of the invention. The application developer determines (102) which unmanaged functions/procedures are needed, and which DLLs or other modules hold those functions. The application developer creates (104) the managed code source code. The application developer also creates (106), in the managed code source code, a wrapper function which uses the same parameters as the unmanaged code that is to be called. The application developer compiles (108) the managed code application into its IL format.

The user loads (110) the managed code application onto the code execution system. The user launches (112) the managed application. The execution engine validates (114) the managed code. The JIT compiler generates (116) an executable format of the managed application, which is executed (118) by the code execution system. The managed code application locates (120) the unmanaged code module which it needs to call; it does so either directly or through the execution environment or the user. Upon encountering the wrapper function, the execution engine generates (122) a dynamic assembly, such as via the Reflection facility, and includes in the dynamic assembly the parameters specified by the wrapper function and the location of the unmanaged code module. The managed code makes (124) a call to the corresponding stub function inside the dynamically generated assembly using Reflection. The code execution engine notices (126) that the call to the dynamic assembly is actually a call to an unmanaged code module and calls the desired function inside the unmanaged code. The system executes (128) the unmanaged function. Upon completion of the unmanaged code function, operation control passes (130) back through the dynamic assembly to the managed code module, whose execution continues.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of calling a code module from managed code in a managed code environment, wherein the location of the code module is not known at compile-time of the managed code, the method comprising:
determining the location of the code module at runtime of the managed code;
generating a dynamic assembly in response to a wrapper function in the managed code;
executing the dynamic assembly; and
calling the code module from the dynamic assembly.

2. The method of claim 1 wherein generating the dynamic assembly comprises:
including in the dynamic assembly data identifying the code module.

3. The method of claim 2 wherein generating the dynamic assembly further comprises:
including in the dynamic assembly data identifying a function in the code module.

4. The method of claim 3 wherein generating the dynamic assembly further comprises:
including in the dynamic assembly data identifying parameters to be passed to and/or from the function.

5. The method of claim 4 wherein the various identifying data are specified in the wrapper function.

6. The method of claim 5 wherein the code module comprises an unmanaged code module.

7. The method of claim 1 wherein the code module comprises an unmanaged code module.

8. The method of claim 7 wherein the managed code environment comprises a Microsoft .NET environment.

9. The method of claim 8 wherein generating the dynamic assembly comprises:
calling the Reflection facilities of the .NET environment.

10. The method of claim 1 wherein determining the location of the code module comprises:
searching a directory listing of a computer system on which the managed code environment is running.

11. The method of claim 10 wherein the searching is performed by the managed code.

12. The method of claim 10 wherein the searching is performed by the managed code environment.

13. A method of creating managed code that is able to call, at runtime, a code module whose location is not known at the time of creating the managed code, the managed code for later execution in a managed code environment, the method comprising:
authoring first source code comprising functions executable in the managed code environment;
authoring second source code comprising a wrapper function identifying a function in the code module; and
compiling the first source code and the second source code into the managed code.

14. The method of claim 13 wherein authoring the second source code further includes the wrapper function further identifying parameters to pass to and/or from the function in the code module.

15. The method of claim 13 wherein the wrapper function identifies the function in the code module by function name.

16. The method of claim 13 wherein the managed code environment comprises the Microsoft .NET environment, and the compiling comprises generating an Intermediate Language representation of the first and second source code.

17. The method of claim 13 wherein authoring the second source code comprises including a call to the Reflection facility of the .NET environment.

18. The method of claim 13 wherein the code module comprises an unmanaged code module.

19. An apparatus comprising:
a processor for performing logic operations;
a memory and storage system storing data and code including,
a managed code environment,
an unmanaged code module, and
managed code including a wrapper function specifying a function in the unmanaged code module but not specifying a location of the managed code module.

20. The apparatus of claim 19 wherein:
the wrapper function further specifying parameters to pass to and/or from the function in the unmanaged code module.

21. The apparatus of claim 20 wherein the managed code environment comprises the Microsoft .NET environment.

22. The apparatus of claim 21 wherein the unmanaged code module comprises legacy code.

23. The apparatus of claim 20 further comprising:
a dynamic assembly created at runtime in response to the wrapper function, the dynamic assembly specifying the function in the unmanaged code module and the location of the unmanaged code module.

24. The apparatus of claim 23 wherein the dynamic execution environment comprises the Microsoft .NET environment and the dynamic assembly has been generated by the .NET Reflection facility.

25. An article of manufacture comprising:
a machine-accessible medium including data that, when accessed by a computer having a managed code environment, cause the computer to,
execute managed code,
determine a location of an unmanaged code module, and
generate a dynamic assembly in response to a wrapper function in the managed code, the dynamic assembly specifying the location of the unmanaged code module and a function in the unmanaged code module,
the managed code not specifying the location of the unmanaged code module.

26. The article of manufacture of claim 25 wherein the machine-accessible medium further includes data that cause the machine to:
generate the dynamic assembly to further specify parameters to pass to and/or from the function in the unmanaged code module.

27. The article of manufacture of claim 25 wherein the managed code environment comprises the Microsoft .NET environment, and the machine-accessible medium further includes data that cause the machine to:
trigger the .NET Reflection facility to generate the dynamic assembly.
